(19) United States
(12) Patent Application Publication
(10) Pub. No.: US 2010/0122244 A1
(43) Pub. Date: May 13, 2010

(54) UPGRADE METHOD AND STORAGE MEDIUM

(75) Inventor: Yoshiyuki Sato, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/616,008

(22) Filed: Nov. 10, 2009

(30) Foreign Application Priority Data
Nov. 12, 2008 (JP) 2008-290324

(51) Int. Cl. G06F 9/44

(52) U.S. Cl. 717/168

(57) ABSTRACT

The present invention provides a method of upgrading software to control an apparatus. The method includes obtaining a code of an error which has occurred in the apparatus, searching for software to prevent the error from occurring in the apparatus based on the obtained code, and providing information of the searched software to the apparatus.

### BACKGROUND OF THE INVENTION

1. Field of the Invention

The present invention relates to an upgrade method and a storage medium.

2. Description of the Related Art

An exposure apparatus is used to manufacture a fine semiconductor device such as a semiconductor memory or a logic circuit using the photolithography technique. In recent years, the trend is to have the exposure apparatus with a higher accuracy and higher throughput. To meet this trend, software of a larger scale is used to control the exposure apparatus. Upgrade (or installation) of software makes the apparatus down time longer. Japanese Patent Laid-Open No. 11-296352 has proposed a technique of efficiently upgrading (or installing) software. In Japanese Patent Laid-Open No. 11-296352, whether upgrade is possible is determined by comparing the remaining capacity of the hardware resource and a capacity necessary for installing software.

When upgrading software in an exposure apparatus, generally, programs for additional functions and bug correction, and new parameter data and tools stored in a recording medium are totally installed in the apparatus. However, when all programs and tools stored in the recording medium are installed in the apparatus, even programs and tools which are unnecessary for the apparatus are also installed. This prolongs the time of the upgrade operation and also the down time of the apparatus.

### SUMMARY OF THE INVENTION

According to one aspect of the present invention, there is provided a method of upgrading software to control an apparatus, the method including obtaining a code of an error which has occurred in the apparatus, searching for software to prevent the error from occurring in the apparatus based on the obtained code, and providing information of the searched software to the apparatus.

Further features of the present invention will become apparent from the following description of exemplary embodiments with reference to the attached drawings.

### BRIEF DESCRIPTION OF THE DRAWINGS

FIG. 1 is a schematic perspective view showing the outer appearance of an exposure apparatus according to an embodiment of the present invention.

FIG. 2 is a schematic view showing the internal arrangement of the exposure apparatus shown in FIG. 1.

FIG. 3 is a schematic block diagram showing the control relationship in the exposure apparatus shown in FIG. 1.

FIG. 4 is a flowchart for explaining an example of processing of upgrading software to control the exposure apparatus shown in FIG. 1.

FIG. 5 is a flowchart illustrating details of apparatus status obtaining in step S1002 shown in FIG. 4.

FIG. 6 is a view showing an example of an error history file which records errors that have occurred in the exposure apparatus shown in FIG. 1.

FIG. 7 is a view showing an example of a status file which records changes in the apparatus status of the exposure apparatus shown in FIG. 1.

FIG. 8 is a flowchart illustrating details of correction program installation in step S1006 shown in FIG. 4.

FIG. 9 is a flowchart for explaining another example of processing of upgrading software to control the exposure apparatus shown in FIG. 1.

FIG. 10 is a schematic view showing the arrangement of a system according to the embodiment of the present invention.

FIG. 11 is a view showing an example of a correction program management database built in the management apparatus shown in FIG. 10.

FIG. 12 is a flowchart for explaining an example of upgrade processing in the system shown in FIG. 10.

### DESCRIPTION OF THE EMBODIMENTS

Various embodiments of the present invention will be described below with reference to the accompanying drawings. Note that the same reference numerals denote the same members throughout the drawings, and a repetitive description thereof will not be given.

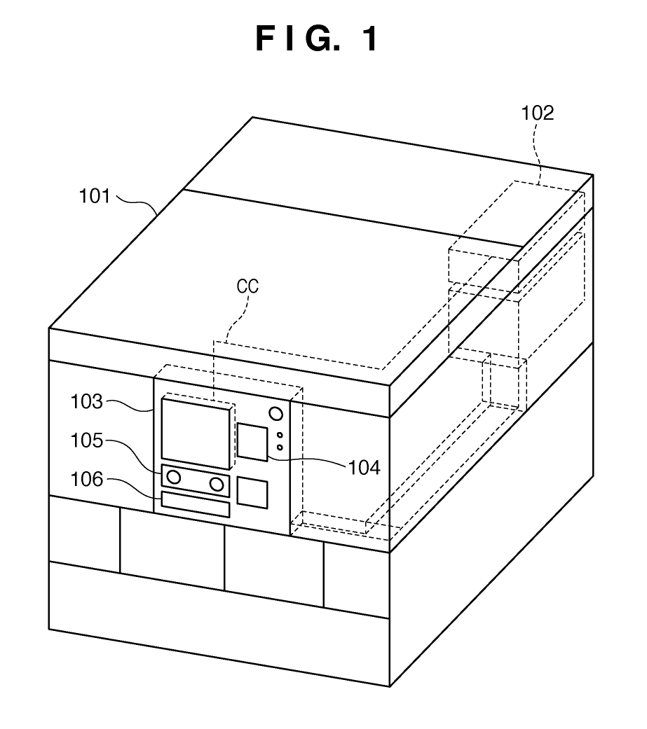

FIG. 1 is a schematic perspective view showing the outer appearance of an exposure apparatus 1 according to an embodiment of the present invention. The exposure apparatus 1 is a projection exposure apparatus which projects the pattern of a reticle (or mask) onto a substrate (wafer) and exposes the substrate.

As shown in FIG. 1, the exposure apparatus 1 includes a chamber 101, a workstation (WS) 102, a first display unit 103, a second display unit 104, an operation unit 105, and an input unit 106. Note that the first display unit 103, the second display unit 104, the operation unit 105, and the input unit 106 in the exposure apparatus 1 constitute a console unit.

The chamber 101 accommodates the exposure apparatus main body and maintains the temperature-controlled internal environment.

The WS 102 is formed from a computer which is specialized to processing for controlling the exposure apparatus main body.

The first display unit 103 is a display unit for the workstation (WS) and displays predetermined information. The first display unit 103 is formed from a flat panel such as an EL (Electro-Luminescence), plasma, or liquid crystal display panel, and arranged on the front side of the chamber 101. The first display unit 103 is connected to the WS 102 via a communication cable CC.

The second display unit 104 is arranged on the front side of the chamber 101, like the first display unit 103, and displays image information obtained via an image sensing unit in the exposure apparatus main body.

The operation unit 105 is arranged on the front side of the chamber 101 and includes an operation panel and various kinds of switches such as an ON/OFF switch and an emergency stop switch to perform a predetermined operation (e.g., instruction input) for the exposure apparatus 1.

The input unit 106 is arranged on the front side of the chamber 101 and includes a keyboard and a mouse for the workstation (WS).

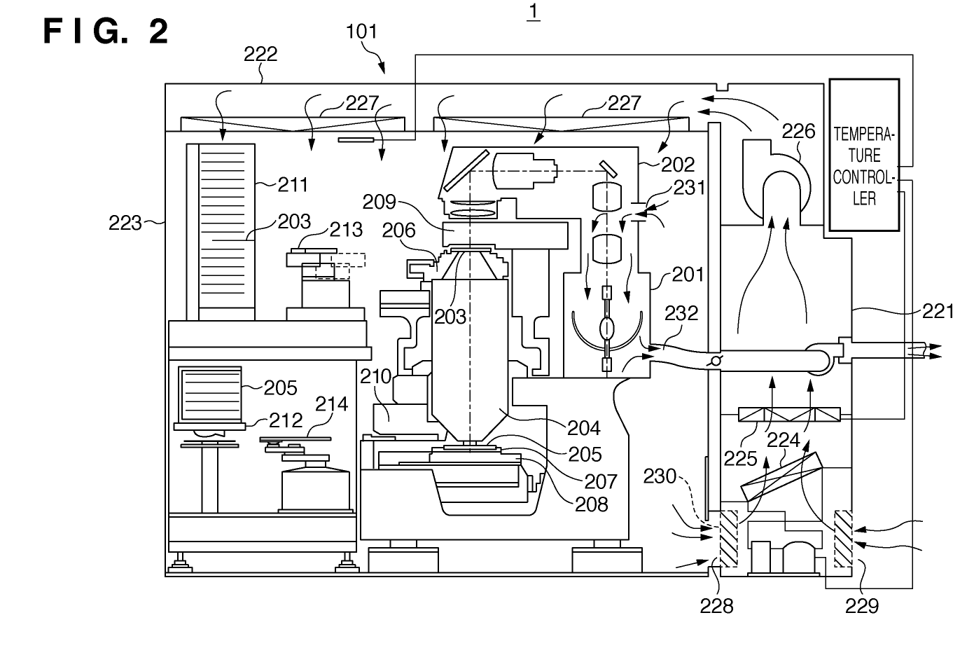

FIG. 2 is a schematic view showing the internal arrangement of the exposure apparatus 1. In this embodiment, the exposure apparatus main body accommodated in the chamber 101 transfers the pattern of a reticle 203 onto a wafer 205 by step-and-repeat, as shown in FIG. 2. Step-and-scan or any other exposure scheme is also applicable.

A light beam emitted by a light source unit 201 illuminates the reticle 203 via an illumination optical system 202. The light beam which has passed through the reticle 203 to reflect its pattern forms an image on the wafer 205 via a projection optical system 204. Note that exposure is performed while maintaining the reticle 203 held on a reticle stage 206 for movably holding the reticle 203 and the wafer 205 vacuum-absorbed by a wafer chuck 207. A wafer stage 208 supports the wafer chuck 207 so as to move it in the respective axial directions.

A reticle detection system 209 is arranged above the reticle 203 to detect its misalignment. An off-axis detection system 210 is arranged above the wafer stage 208 to be adjacent to the projection optical system 204 so as to detect the relative positions of a reference mark and an alignment mark on the wafer 205.

In addition, a reticle library 211 and a wafer carrier elevator 212 are arranged adjacent to the exposure apparatus main body. The reticle 203 and wafer 205 are transferred to the exposure apparatus main body via a reticle transfer system 213 and a wafer transfer system 214, respectively.

The chamber 101 includes an air conditioning chamber 221 which regulates the air temperature, a filter box 222 which removes (filters) minute foreign substances to form a uniform flow of clean air, and a booth 223 which separates the internal environment from the outside.

In the chamber 101, a cooler 224 and a heater 225 arranged in the air conditioning chamber 221 regulate the temperature of air. The air is supplied into the booth 223 via a fan 226 and an air filter 227. The air supplied into the booth 223 returns to the air conditioning chamber 221 via a return port 228 and thus circulates through the chamber 101. However, the chamber 101 may not form a perfect circulatory system. To maintain a positive pressure in the booth 223, the chamber 101 introduces external air (about 10% the amount of air to be circulated) from an air inlet 229 provided in the air conditioning chamber 221. Note that each of the return port 228 and the air inlet 229 has a chemisorption filter 230 to remove chemical substances contained in air.

The light source unit 201 has an inlet port 231 and an exhaust port 232 to cool an ultra-high pressure mercury lamp or exhaust a toxic gas generated under abnormal conditions. Hence, air inside the booth 223 is partially forcibly exhausted to the outside (e.g., plant facilities) via the light source unit 201 and an exhaust fan provided in the air conditioning chamber 221.

The chamber 101 having the above-described arrangement can maintain a predetermined internal environment for accommodating the exposure apparatus main body and also maintain clean air.

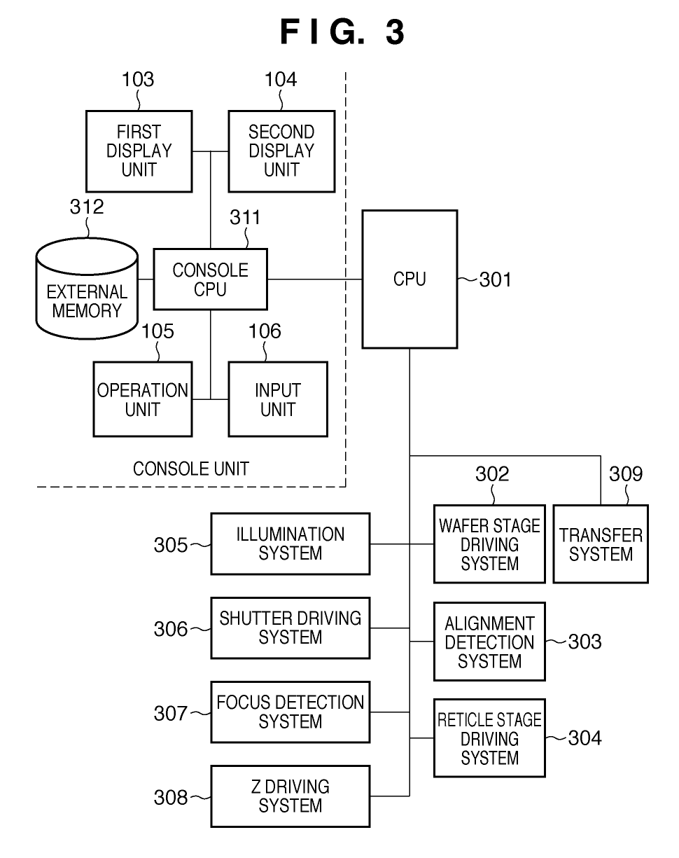

FIG. 3 is a schematic block diagram showing the control relationship in the exposure apparatus 1. Referring to FIG. 3, a CPU 301 is incorporated in the WS 102. The CPU 301 is formed from a central processing unit such as a microcomputer or a minicomputer. The CPU 301 controls a wafer stage driving system 302 including the wafer stage 208, an alignment detection system 303 including the reticle detection system 209 and the off-axis detection system 210, and a reticle stage driving system 304 including the reticle stage 206. The CPU 301 also controls an illumination system 305 including the light source unit 201 and the illumination optical system 202, a shutter driving system 306, a focus detection system 307, a Z driving system 308, and a transfer system 309 including the reticle transfer system 213 and the wafer transfer system 214.

The console unit including the first display unit 103, the second display unit 104, the operation unit 105, the input unit 106, a console CPU 311, and an external memory 312 gives the CPU 301 various kinds of commands and parameters associated with the operation of the exposure apparatus 1. In other words, the console unit exchanges information with the user.

The console CPU 311 is formed from a central processing unit such as a microcomputer or a minicomputer and controls the first display unit 103, the second display unit 104, the operation unit 105, the input unit 106, and the external memory 312. The external memory 312 is, for example, a hard disk which incorporates a database to record various kinds of parameters, management data, and user groups.

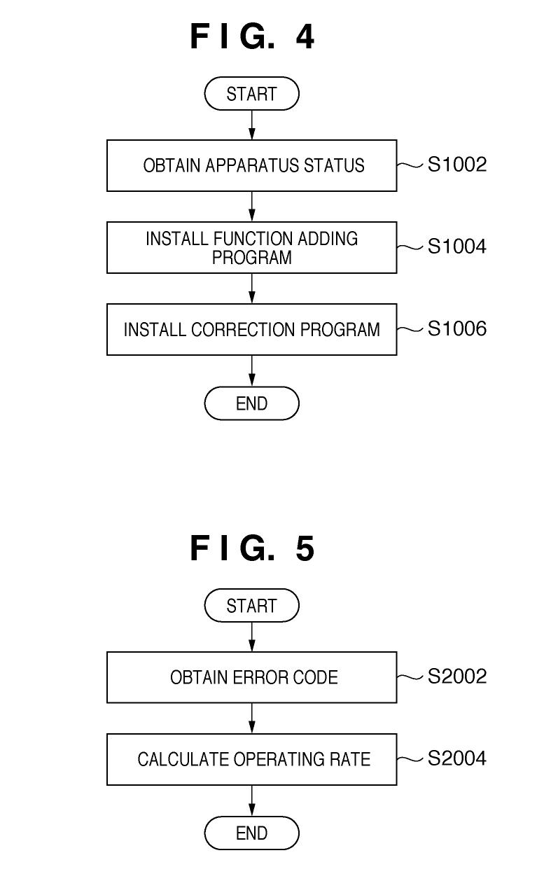

FIG. 4 is a flowchart for explaining an example of processing of upgrading software (program) to control the exposure apparatus 1. Note that a program for executing the upgrade processing is assumed to be installed from a recording medium connected to a medium interface (not shown) and stored in the external memory 312 via the console CPU 311. A recording medium which stores a program (to be referred to as a “function adding program”) for adding a function to the exposure apparatus 1 or a program (to be referred to as a “correction program”) for performing correction to prevent errors from occurring in the exposure apparatus 1 is assumed to be connected to the medium interface.

In this embodiment, the upgrade processing shown in FIG. 4 is executed by causing the console CPU 311 to comprehensively control the units of the exposure apparatus 1. However, the upgrade processing shown in FIG. 4 may be executed by the CPU 301 in the WS 102 or cooperatively by the console CPU 311 and the CPU 301.

In step S1002, the console CPU 311 obtains the current apparatus status of the exposure apparatus 1.

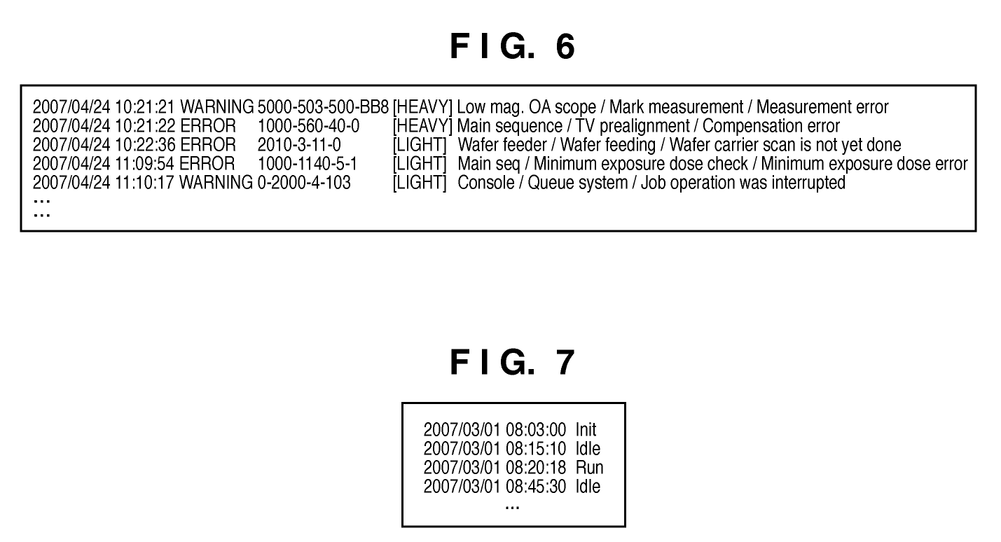

More specifically, as shown in FIG. 5, the console CPU 311 obtains, in step S2002, error codes from the error history of errors that have occurred in the exposure apparatus 1. When an error has occurred in the exposure apparatus 1, occurrence date/time, an error type (Error, Warning, or Message), an error code, information representing the seriousness of the error, and an error title are recorded in the error history file, as shown in FIG. 6. The console CPU 311 can obtain the error codes of errors which have occurred in the exposure apparatus 1 by referring to the error history file as shown in FIG. 6. The console CPU 311 can also obtain the occurrence frequency of each error (i.e., each error code) by extracting errors that have occurred during a predetermined period (for example, one month) and counting identical error codes. In other words, the console CPU 311 can obtain the error code of an error which has occurred in the exposure apparatus 1 a predetermined number of times or more. FIG. 5 is a flowchart illustrating details of the apparatus status obtaining in step S1002. FIG. 6 is a view showing an example of an error history file which records errors that have occurred in the exposure apparatus 1.

In step S2004, the console CPU 311 calculates the operating rate of the exposure apparatus 1. The exposure apparatus has four apparatus statuses, that is, Init (initialization progresses), Idle (standby), Run (exposure progresses), and MA (waiting for manual assist). When the apparatus status has changed, the time of the apparatus status change and the new apparatus status are recorded in a status file, as shown in FIG. 7. The console CPU 311 reads out the apparatus status change times and the apparatus statuses from the status file as shown in FIG. 7, and totals the times of apparatus status “Run”, thereby calculating the operating rate of the exposure apparatus 1. However, the processing (step S2004) of calculating the operating rate of the exposure apparatus 1 may not always be performed. This processing is needed when determining, based on the operating rate of the exposure apparatus 1, whether to execute processing of installing a correction program, as will be described later. FIG. 7 is a view showing an example of a status file which records changes in the apparatus status of the exposure apparatus 1.

Referring back to FIG. 4, in step S1004, the console CPU 311 installs, in the exposure apparatus 1, the function adding program (software) from the recording medium connected to the medium interface (not shown). That is, information of the function adding program (software) is provided to the exposure apparatus 1 in step S1004.

In step S1006, the console CPU 311 installs, in the exposure apparatus 1, a correction program (software) from the recording medium connected to the medium interface (not shown).

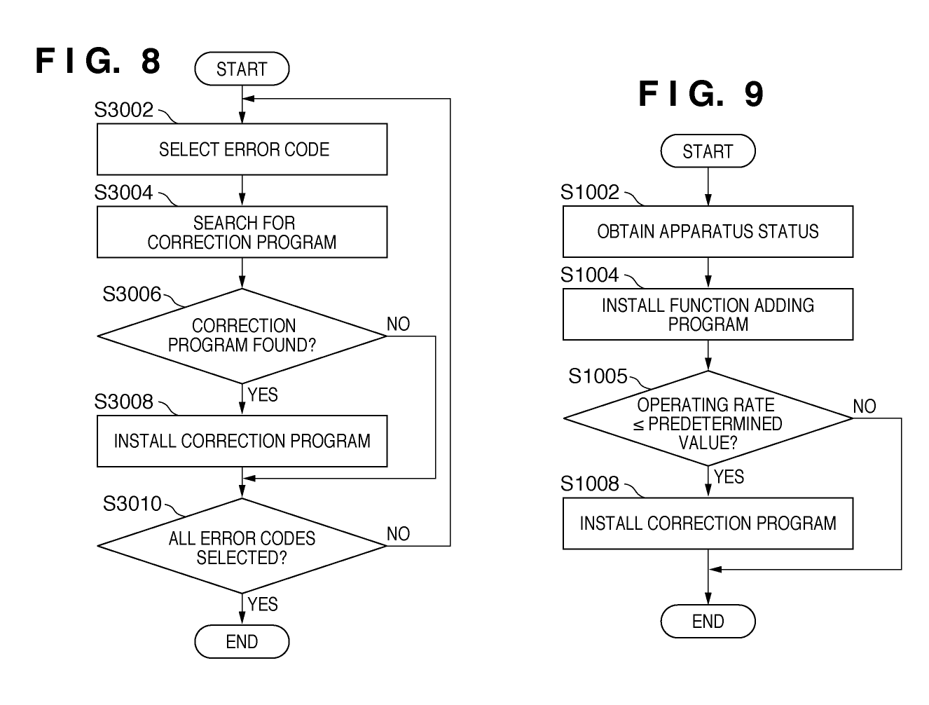

FIG. 8 is a flowchart illustrating details of the correction program installation in step S1006. In step S3002, the console CPU 311 selects one of the error codes obtained in step S1002 (step S2002). At this time, the selection target may include not all the error codes obtained in step S1002 (step S2002) but, for example, only the error codes of errors having high occurrence frequencies (i.e., errors which have occurred a predetermined number of times or more). Alternatively, the selection target may include only error codes for each of which the information representing the seriousness of the error in the exposure apparatus 1 has a preset value or more.

In step S3004, based on the error code selected in step S3002, the console CPU 311 searches the recording medium for a correction program for performing correction to prevent an error of the error code from occurring. Namely, the console CPU 311 searches a plurality of programs (software) stored in a recording medium or the like for a correction program for performing correction to prevent errors of the error code obtained in step S1002 (step S2002) from occurring in the exposure apparatus 1.

In step S3006, the console CPU 311 determines whether the correction program is found in step S3004.

Upon determining that the correction program is found, in step S3008, the console CPU 311 installs the correction program found in step S3004 in the exposure apparatus 1. That is, information of the correction program (software) is provided to the exposure apparatus 1 in step S3008.

On the other hand, if it is determined that the correction program is not found, the process advances to step S3010.

In step S3010, the console CPU 311 determines whether all error codes obtained in step S1002 (step S2002) have been selected in step S3002. Note that when the selection target includes only error codes corresponding to high occurrence frequencies, the console CPU 311 determines whether all error codes corresponding to high occurrence frequencies have been selected. Alternatively, when the selection target includes only error codes for each of which the information representing the seriousness of errors that have occurred in the exposure apparatus 1 has a preset value or more, the console CPU 311 determines whether all error codes for each of which the information representing the seriousness of errors has a preset value or more have been selected.

If it is determined that not all error codes obtained in step S1002 (step S2002) have been selected, the process returns to step S3002 to repeat the processing from there.

If it is determined that all error codes obtained in step S1002 (step S2002) have been selected, the processing ends.

In this embodiment, based on the error code of an error that has occurred in the exposure apparatus 1 (or an error having a high occurrence frequency or an error whose seriousness is equal to or more than a preset value), only a correction program for performing correction to prevent such an error from occurring can be installed in the exposure apparatus 1. That is, it is possible to install only necessary software in the exposure apparatus 1 in accordance with its apparatus status, instead of installing all correction programs stored in a recording medium. Hence, this embodiment enables to shorten the down time of the apparatus by efficiently performing upgrade in a short time.

It is also possible to determine, based on the operating rate of the exposure apparatus 1, whether to execute processing of installing a correction program, as shown in FIG. 9. More specifically, the console CPU 311 installs the function adding program in the exposure apparatus 1 (step S1004), and then determines in step S1005 whether the operating rate of the exposure apparatus 1 calculated in step S2004 has a predetermined value or less. If it is determined that the operating rate of the exposure apparatus 1 does not have the predetermined value or less, the processing ends without installing any correction program in the exposure apparatus 1. On the other hand, upon determining that the operating rate of the exposure apparatus 1 has the predetermined value or less, the console CPU 311 installs a correction program in the exposure apparatus 1 (step S1008). In this case, only when the operating rate of the exposure apparatus 1 has the predetermined value or less, necessary software (correction program) may be installed. This further shortens the down time of the apparatus. FIG. 9 is a flowchart for explaining another example of processing of upgrading software (program) to control the exposure apparatus 1.

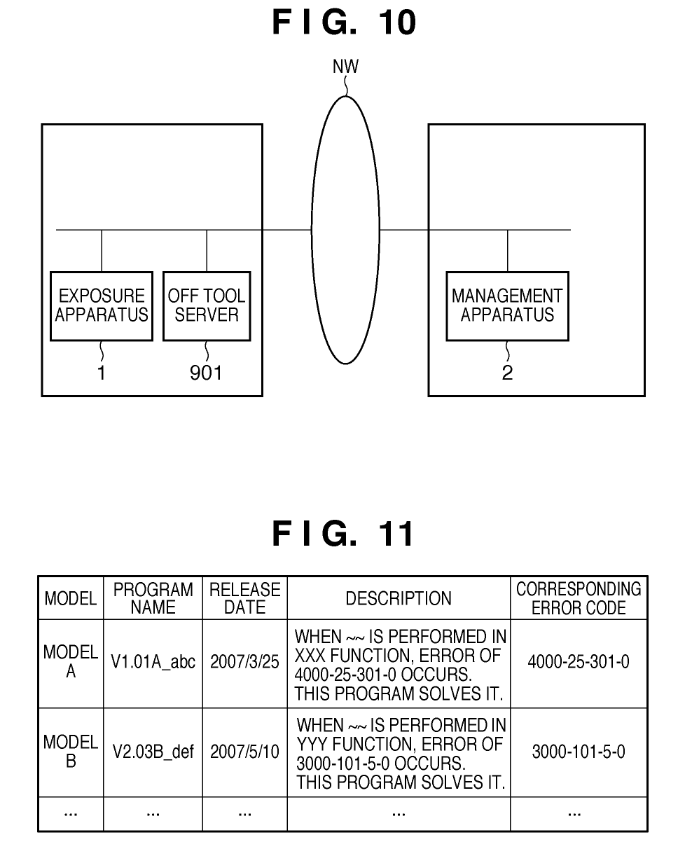

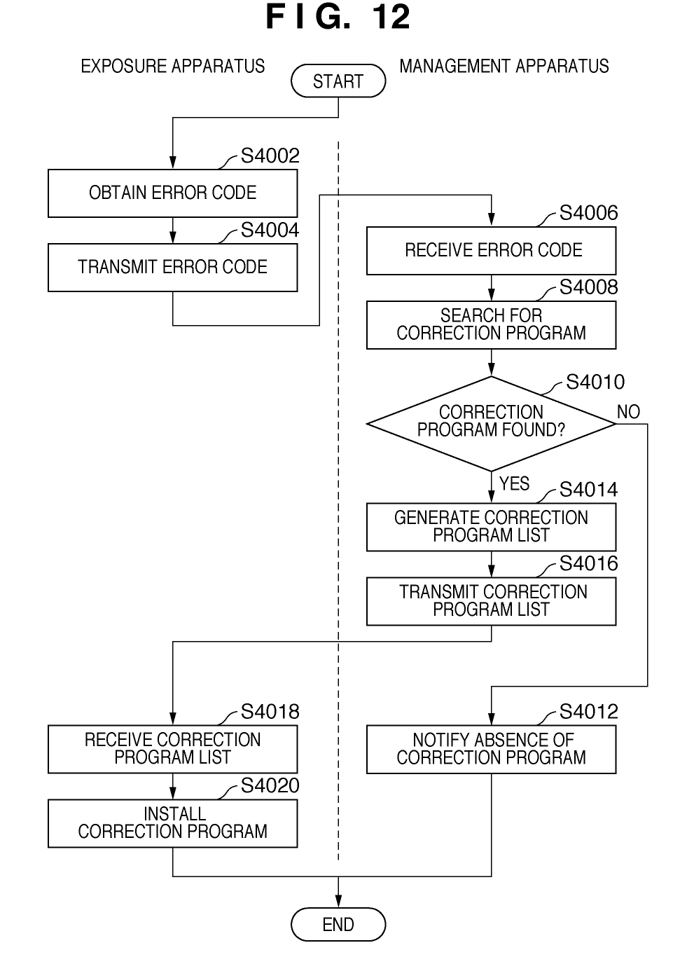

The above-described upgrade processing is also applicable to a system (remote support service system) including the exposure apparatus 1 and a management apparatus 2, as shown in FIG. 10. The management apparatus 2 is connected to the exposure apparatus 1 via a network NW to manage the exposure apparatus 1 (provide a service to the exposure apparatus 1) from a remote site. The management apparatus 2 can include a computer serving as a server. Various databases including a correction program management database shown in FIG. 11 are built in the management apparatus 2. The correction program management database shown in FIG. 11 manages information such as a corresponding model, a program name, a release date, a description, and a corresponding error code for each correction program which performs correction to prevent errors from occurring in the exposure apparatus 1. Note that in this embodiment, the exposure apparatus 1 and the management apparatus 2 exchange information not directly but via an off tool server 901 in consideration of security. FIG. 10 is a schematic view showing the arrangement of a system according to the embodiment. FIG. 11 is a view showing an example of the correction program management database built in the management apparatus 2.

FIG. 12 is a flowchart for explaining an example of upgrade processing in the system shown in FIG. 10.

In step S4002, the exposure apparatus 1 obtains the error codes of errors which have occurred in itself, as in step S2002.

In step S4004, the exposure apparatus 1 transmits the error codes obtained in step S4002 to the management apparatus 2 via the off tool server 901 and the network NW.

In step S4006, the management apparatus 2 receives the error codes transmitted from the exposure apparatus 1 via the network NW.

In step S4008, the management apparatus 2 refers to the correction program management database shown in FIG. 11 and, based on the error codes received from the exposure apparatus 1, searches for correction programs to prevent errors from occurring in the exposure apparatus 1.

In step S4010, the management apparatus 2 determines whether the correction programs are found in step S4008.

Upon determining that the correction programs are not found, in step S4012, the management apparatus 2 notifies the exposure apparatus 1 that no correction programs exist or that absence of correction program (i.e., correction programs for correcting errors of the error codes received from the exposure apparatus 1 have not been released).

On the other hand, upon determining that the correction programs are found, in step S4014 the management apparatus 2 generates a list of the correction programs found in step S4008.

In step S4016, the management apparatus 2 transmits the correction program list generated in step S4014 to the exposure apparatus 1 via the network NW.

In step S4018, the exposure apparatus 1 receives the correction program list transmitted from the management apparatus 2 via the network NW and the off tool server 901.

In step S4020, the exposure apparatus 1 installs the correction programs from a recording medium connected to the medium interface (not shown) in accordance with the correction program list received in step S4018, as in step S1006. Note that if a correction program included in the correction program list received from the management apparatus 2 is not stored in the recording medium, the exposure apparatus 1 may request the management apparatus 2 to provide the correction program.

As described above, even in the system shown in FIG. 10, necessary software (correction program) may be installed in the exposure apparatus 1. This shortens the down time of the apparatus by efficiently performing upgrade in a short time.

Instead of generating a correction program list and transmitting it to the exposure apparatus 1 in steps S4014 and S4016, the management apparatus 2 may transmit (provide) the correction programs found in step S4008 themselves to the exposure apparatus 1. In this case, the exposure apparatus 1 installs the correction programs provided from the management apparatus 2. The method of upgrading software disclosed above may be applicable to another apparatus, such as an image forming apparatus including a photocopier.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2008-290324 filed on Nov. 12, 2008, which is hereby incorporated by reference herein in its entirety.

What is claimed is:

1. A method of upgrading software to control an apparatus, the method comprising:
obtaining a code of an error which has occurred in the apparatus;
searching for software to prevent the error from occurring in the apparatus based on the obtained code; and
providing information of the searched software to the apparatus.

2. The method according to claim 1, wherein the providing includes installing the searched software in the apparatus.

3. The method according to claim 1, wherein the obtaining obtains, out of errors which have occurred in the apparatus, a code of an error which has occurred a number of times not less than a predetermined number of times.

4. The method according to claim 1, wherein
the code includes information representing seriousness of the error which has occurred in the apparatus, and
the searching searches for software to prevent an error having a seriousness not less than a preset value from occurring in the apparatus.

5. The method according to claim 1, further comprising:
obtaining a status of the apparatus to calculate an operating rate of the apparatus; and
determining whether the calculated operating rate has a value not greater than a predetermined value,
wherein if the determining determines that the calculated operating rate has a value not more than the predetermined value, the searching and the providing are executed.

6. A method of upgrading software to control an exposure apparatus in a system including the exposure apparatus and a management apparatus, the method comprising:
the exposure apparatus obtaining a code of an error which has occurred therein;
the exposure apparatus transmitting the obtained code to the management apparatus;
the management apparatus searching for software to prevent the error from occurring in the exposure apparatus based on the transmitted code;
the management apparatus providing the searched software to the exposure apparatus; and
the exposure apparatus installing the provided software therein.

7. A method of upgrading software to control an exposure apparatus in a system including the exposure apparatus and a management apparatus, the method comprising:
the exposure apparatus obtaining a code of an error which has occurred therein;
the exposure apparatus transmitting the obtained code to the management apparatus;
the management apparatus searching for software to prevent the error from occurring in the exposure apparatus based on the transmitted code; and
the management apparatus transmitting a list of the searched software to the exposure apparatus.

8. The method according to claim 7, further comprising
the exposure apparatus installing a software therein in accordance with the transmitted list.

9. A computer-readable storage medium storing a program which causes a computer to execute a method of upgrading software to control an apparatus, the program causing the computer to execute:
obtaining a code of an error which has occurred in the apparatus;
searching for software to prevent the error from occurring in the apparatus based on the obtained code; and
providing information of the searched software to the apparatus.

10. The method according to claim 8, wherein the obtaining obtains, out of errors which have occurred in the apparatus, a code of an error which has occurred a number of times not less than a predetermined number of times.

11. The method according to claim 8, wherein
the code includes information representing seriousness of the error which has occurred in the apparatus, and
the searching searches for software to prevent an error having a seriousness not less than a preset value from occurring in the apparatus.

12. The method according to claim 8, further comprising:
obtaining a status of the exposure apparatus to calculate an operating rate of the exposure apparatus; and
determining whether the calculated operating rate has a value not greater than a predetermined value,
wherein if the determining determines that the calculated operating rate has a value not more than the predetermined value, the searching and the providing are executed.

13. The computer-readable storage medium according to claim 9, wherein the providing includes installing the searched software in the apparatus.

14. The computer-readable storage medium according to claim 9, wherein the obtaining obtains, out of errors which have occurred in the apparatus, a code of an error which has occurred a number of times not less than a predetermined number of times.

15. The computer-readable storage medium according to claim 9, wherein
the code includes information representing seriousness of the error which has occurred in the apparatus, and
the searching searches for software to prevent an error having a seriousness not less than a preset value from occurring in the apparatus.

16. The computer-readable storage medium according to claim 9, wherein the program causing the computer to execute further:
obtaining a status of the apparatus to calculate an operating rate of the apparatus; and
determining whether the calculated operating rate has a value not greater than a predetermined value,
wherein if the determining determines that the calculated operating rate has a value not more than the predetermined value, the searching and the providing are executed.

17. The method according to claim 1, wherein the apparatus includes an exposure apparatus for exposing a substrate to radiant energy.

18. The computer-readable storage medium according to claim 9, wherein the apparatus includes an exposure apparatus for exposing a substrate to radiant energy.
